(19) United States
(12) Patent Application Publication
(10) Pub. No.: US 2026/0230755 A1
(43) Pub. Date: Aug. 6, 2026

(54) Electroacoustic transductor structure

(71) Applicant: AAC Kaitai Technologies (Wuhan) CO., LTD., Wuhan (CN)

(72) Inventors: Yu Shen, Wuhan (CN); Qiang Dan, Wuhan (CN); Yiwei Zhou, Wuhan (CN); Yang Li, Wuhan (CN)

(21) Appl. No.: 19/344,596

(22) Filed: Sep. 30, 2025

Related U.S. Application Data
(63) Continuation of application No. PCT/CN2025/076004, filed on Feb. 6, 2025.

(51) Int. Cl. H04R 7/06; H04R 7/20; H04R 17/00

(52) U.S. Cl. CPC H04R 7/06; H04R 7/20; H04R 17/00

(57) ABSTRACT

An electroacoustic transducer structure includes: a base; an actuating mechanism including an annular fixed part that surrounds the first direction and is fixed to the base, a first actuating arm and a second actuating arm which are formed in the fixed part, respectively, the fixed part having a first end and a second end that are oppositely oriented in a second direction, the first actuating arm extending from the first end of the fixed part till adjacent the second end of the fixed part, the second actuating arm extending from the second end of the fixed part till adjacent the first end of the fixed part; and a diaphragm. The electroacoustic transducer structure as disclosed may produce a higher SPL.

### FIELD

This application relates to electroacoustic transduction, and more particularly relates to an electroacoustic transductor structure.

### BACKGROUND

FIG. 1 illustrates a conventional electroacoustic transductor structure 200, comprising a base 210, an actuator 220, and a diaphragm 230. The base 210 has a cavity 211, one end of the actuator 220 being fixed to the base 210, another end thereof being suspended to a cantilever 221 above the cavity 211, the diaphragm 230 being fixed to the suspended end of the cantilever 221. Excited by an electrical signal, the cantilever 221 vibrates up and down, driving the diaphragm 230 to move together, whereby a sound pressure is produced.

However, a miniaturized electroacoustic transductor structure has a short cantilever, which can hardly achieve a high sound pressure level (SPL).

Therefore, it is desirable to provide an electroacoustic transductor structure which can promote the sound pressure level.

### SUMMARY

An electroacoustic transductor structure is provided herein, which solves a technical issue of low sound pressure level in conventional technologies.

An electroacoustic transductor structure comprises:

a base having a cavity, the cavity having two openings oppositely arranged in a first direction;

an actuating mechanism comprising an annular fixed part that surrounds the first direction and is fixed to the base, a first actuating arm, and a second actuating arm, the first actuating arm and the second actuating arm being formed in the fixed part, respectively, the fixed part having a first end and a second end that are oppositely oriented in a second direction perpendicular to the first direction, the first actuating arm extending from the first end of the fixed part till adjacent the second end of the fixed part, the second actuating arm extending from the second end of the fixed part till adjacent the first end of the fixed part;

and a diaphragm which covers one of the openings, the diaphragm comprising an annular edge part which surrounds the first direction and is fixed to the fixed part, a body part located in a central area of the edge part and a connecting part elastically connecting the edge part and the body part, two ends of the body part in the second direction being fixed to a terminal end of the first actuating arm and a terminal end of the second actuating arm, respectively.

Optionally, the connecting part has a surround structure a central portion of which is raised in a direction distant from the base.

Optionally, the connecting part comprises a plurality of spring arms arranged at intervals surrounding the first direction, one end of each of the spring arms being connected to the edge part, another end of the each of the spring arms being connected to the body part.

Optionally, the connecting part comprises at least two concaves arranged coaxially surrounding the first direction and a convex joining adjacent two concaves into one piece, the concaves being recessed towards the base relative to the body part.

Optionally, further comprising a rigidity regulating plate, the rigidity regulating plate covering one side of the body part proximal to the opening and being configurable to enhance rigidity of the body part.

Optionally, the actuating mechanism comprises a plurality of the first actuating arms and a plurality of the second actuating arms, a number of the first actuating arms being identical to that of the second actuating arms, the first actuating arms and the second actuating arms being alternately arranged at intervals in a third direction, the third direction being perpendicular to the first direction and the second direction.

Optionally, the actuating mechanism further comprises a first spring part and a second spring part;

the terminal end of the first actuating arm is connected to the second end of the fixed part via the first spring part;

and the terminal end of the second actuating arm is connected to the first end of the fixed part.

Optionally, the actuating mechanism comprises a support layer, a first electrode layer, a piezoelectric layer, and a second electrode layer which are sequentially arranged in the first direction away from the base, the support layer being connected to the base.

Optionally, the actuating mechanism further comprises a passivation layer, the passivation layer being disposed at one side of the second electrode layer distant from the piezoelectric layer.

Optionally, further comprising a frame surrounding the first direction, a first transmission part, and a second transmission part, the frame connecting the edge part and the fixed part, the first transmission part connecting the terminal end of the first actuating arm and the body part, the second transmission part connecting the terminal end of the second actuating arm and the body part.

The present disclosure offers the following benefits: the electroacoustic transductor structure as disclosed herein comprises: a base having a cavity, the cavity having two openings oppositely arranged in a first direction; an actuating mechanism comprising an annular fixed part that surrounds the first direction and is fixed to the base, a first actuating arm, and a second actuating arm, the first actuating arm and the second actuating arm being formed in the fixed part, respectively, the fixed part having a first end and a second end that are oppositely oriented in a second direction perpendicular to the first direction, the first actuating arm extending from the first end of the fixed part till adjacent the second end of the fixed part, the second actuating arm extending from the second end of the fixed part till adjacent the first end of the fixed part; and a diaphragm which covers one of the openings, the diaphragm comprising an annular edge part which surrounds the first direction and is fixed to the fixed part, a body part located in a central area of the edge part and a connecting part elastically connecting the edge part and the body part, two ends of the body part in the second direction being fixed to a terminal end of the first actuating arm and a terminal end of the second actuating arm, respectively. This solution increases the lengths of the first actuating arm and the second actuating arm in the second direction to the utmost extent without increasing the footprint of the electroacoustic transductor structure, thereby effectively increasing movement amplitudes of the terminal end of the first actuating arm and the terminal end of the second actuating arm in the first direction to set a larger volume of air in motion, with a higher sound pressure level created.

### BRIEF DESCRIPTION OF THE DRAWINGS

FIG. 1 is a sectional structural schematic diagram of a conventional electroacoustic transductor structure;

FIG. 2 is a sectional structural schematic diagram of another conventional electroacoustic transductor structure;

FIG. 3 is a schematic diagram of a secondary vibration mode of the electroacoustic transductor structure shown in FIG. 2;

FIG. 4 is a stereoscopic structural schematic diagram of an electroacoustic transductor structure according to some implementations of the present disclosure;

FIG. 5 is an exploded view of FIG. 4;

FIG. 6 is an exploded view of FIG. 4;

FIG. 7 is a sectional view of FIG. 4;

FIG. 8 is a schematic diagram of a primary vibration mode of the electroacoustic transductor structure shown in FIG. 4;

FIG. 9 is a schematic diagram of a secondary vibration mode diagram of the electroacoustic transductor structure shown in FIG. 4;

FIG. 10 is a stereoscopic structural diagram of an electroacoustic transductor structure according to some implementations of the present disclosure;

FIG. 11 is a sectional view of FIG. 10;

FIG. 12 is a structural schematic diagram of a diaphragm in the electroacoustic transductor structure shown in FIG. 10;

FIG. 13 is a stereoscopic structural schematic diagram of an electroacoustic transductor structure according to some implementations of the present disclosure;

FIG. 14 is a sectional view of FIG. 13;

FIG. 15 is a sectional structural view of an electroacoustic transductor structure according to some implementations of the present disclosure;

FIG. 16 is a sectional structural view of an electroacoustic transductor structure according to some implementations of the present disclosure;

FIG. 17 is a schematic diagram of the sectional structure shown in FIG. 16 with the diaphragm being removed;

FIG. 18 is a schematic diagram of the electroacoustic transductor structure shown in FIG. 16 with the diaphragm being removed.

### DETAILED DESCRIPTION OF IMPLEMENTATIONS

Hereinafter, the present disclosure will be further illustrated through example implementations with reference to the accompanying drawings.

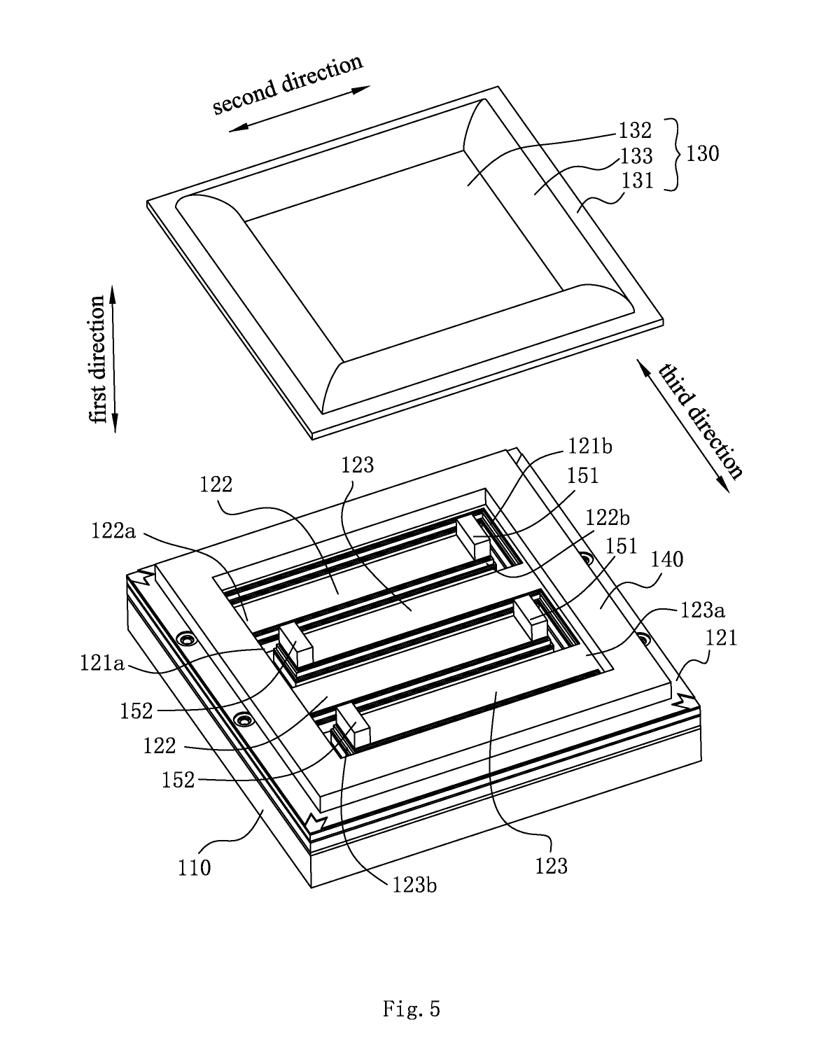

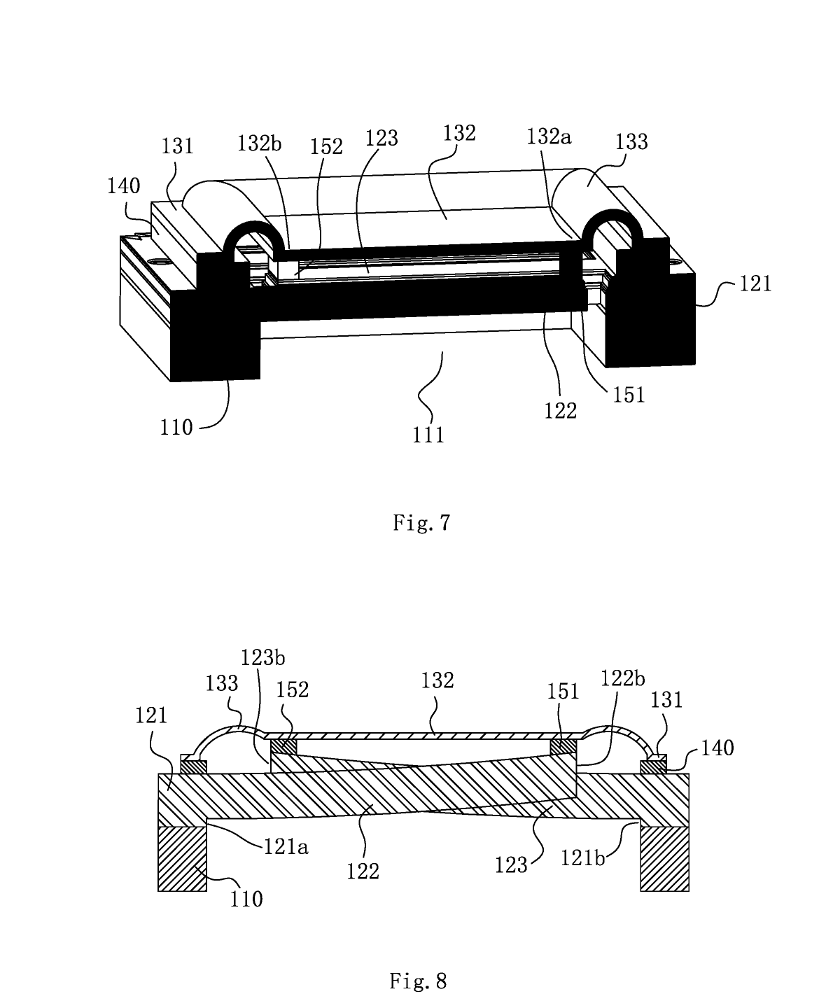

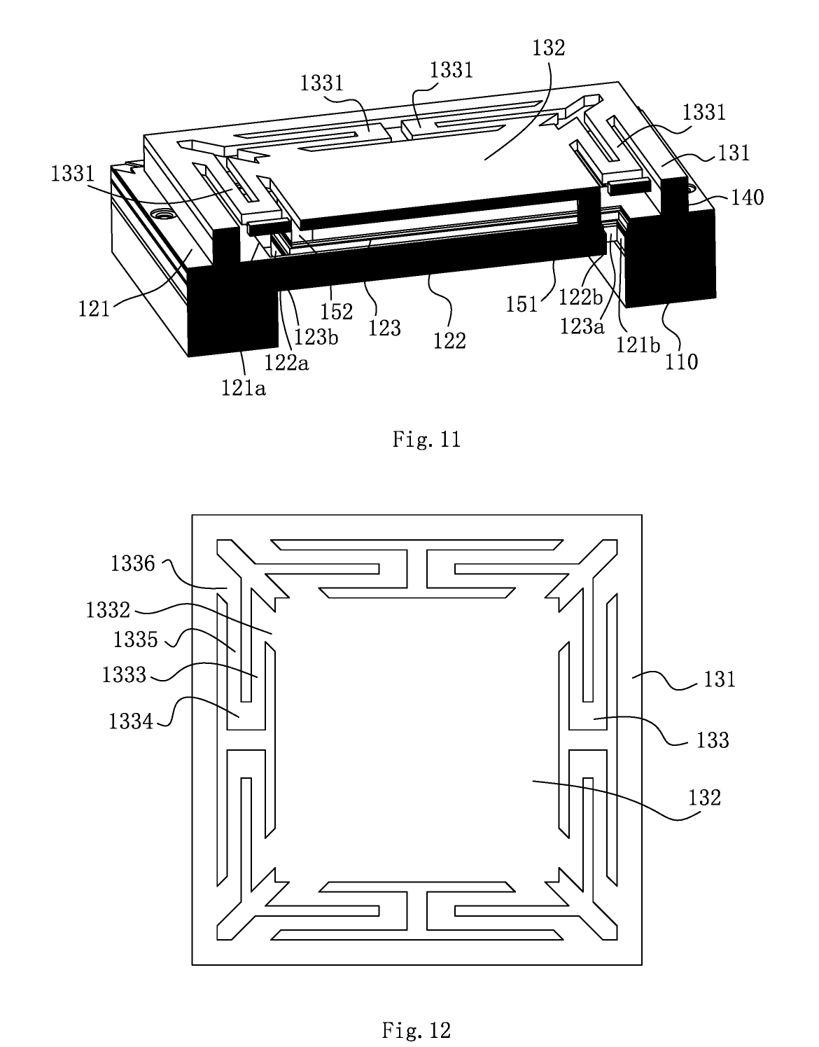

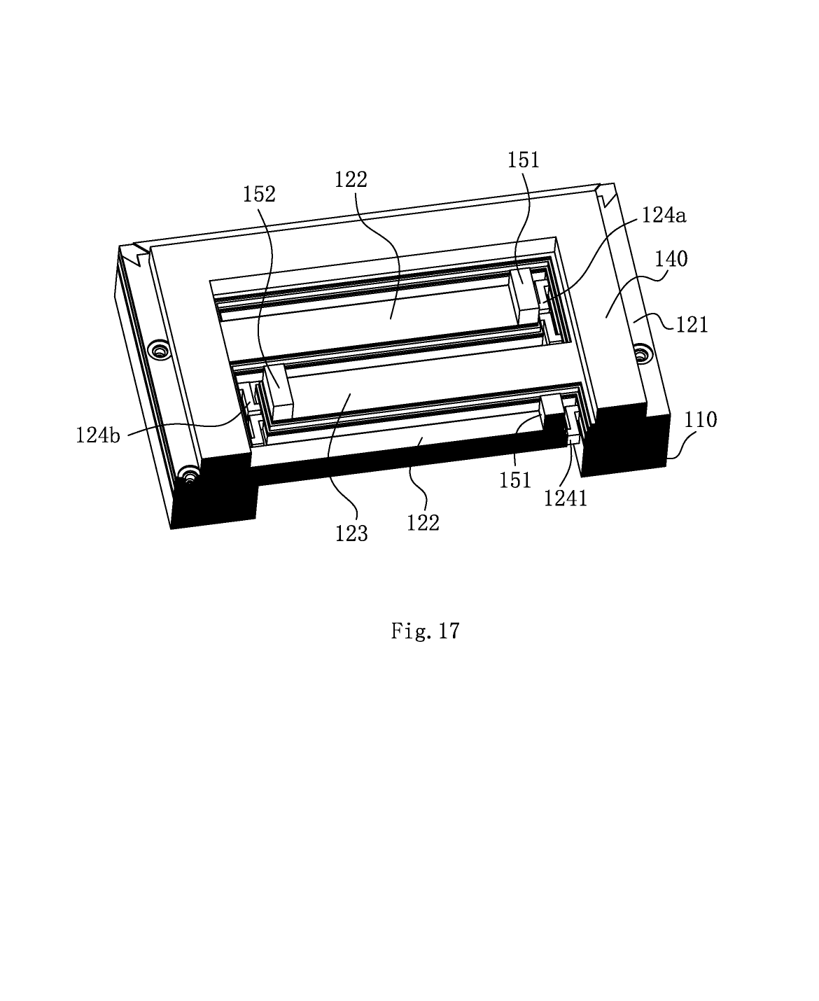

Referring to FIGS. 4 to 18, an implementation of the present disclosure provides an electroacoustic transductor structure 100, comprising a base 110, an actuating mechanism 120, and a diaphragm 130. The base 110 has a cavity 111, the cavity 111 having two openings oppositely arranged in a first direction. The actuating mechanism 120 comprises a fixed part 121, a first actuating arm 122, and a second actuating arm 123. The fixed part 121 is fixed to the base 110 and has a ring structure surrounding the first direction. The fixed part 121 has a first end 121a and a second end 121b oppositely oriented in a second direction, the second direction being perpendicular to the first direction. The first actuating arm 122 is formed in the fixed part 121, a start end 122a of the first actuating arm 122 being fixed to the first end 121a of the fixed part 121, a terminal end 122b of the first actuating arm 122 extending in the second direction till adjacent the second end 121b of the fixed part 121. The second actuating arm 123 is formed in the fixed part 121, a start end 123a of the second actuating arm 123 being fixed to a second end 121b of the fixed part 121, a terminal end 123b of the second actuating arm 123 extending in a second direction till adjacent the first end 121a of the fixed part 121. The diaphragm 130 covers one of the openings; the diaphragm 130 comprises an edge part 131, a body part 132, and a connecting part 133. The edge part 131 is fixed to the fixed part 121 and is of a ring structure surrounding the first direction. The body part 132 is located in a central portion of the edge part 131, the body part 132 having a third end 132a and a fourth end 132b which are oppositely oriented in the second direction, the third end 132a of the body part 132 being fixed to the terminal end 122b of the first actuating arm 122, the fourth end 132b of the body part 132 being fixed to the terminal end 123b of the second actuating arm 123. The connecting part 133 serves to elastically connect the edge part 131 and the body part 132, so that the body part 132 may be driven by the first actuating arm 122 and the second actuating arm 123 to move in the first direction.

In this implementation, the first actuating arm 122 and the second actuating arm 123 extend in the second direction till adjacent the body part 132, respectively, which increases the lengths of the first actuating arm 122 and the second actuating arm 123 in the second direction to the utmost extent without increasing the footprint of the electroacoustic transductor structure 100, thereby effectively increasing movement amplitudes of the terminal end 122b of the first actuating arm 122 and the terminal end 123b of the second actuating arm 123 in the first direction to set a larger volume of air in motion, with a higher sound pressure level created.

Exemplarily, the first direction may be Z-direction.

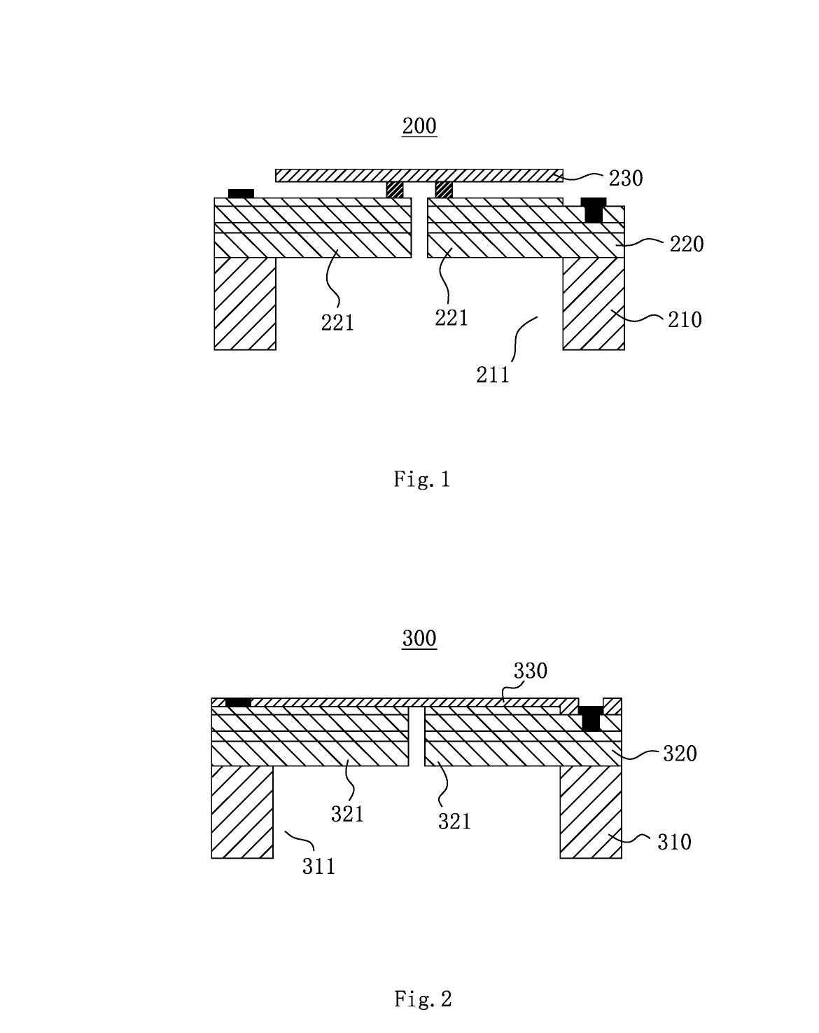

In this implementation, as illustrated in FIG. 8, actuated by an electrical signal, the terminal end 122b of the first actuating arm 122 and the terminal end 123b of the second actuating arm 123 may move vertically in the first direction. In a primary vibration mode, since the lengths of the first actuating arm 122 and the second actuating arm 123 in the second direction are significantly extended in this implementation compared with the conventional technology illustrated in FIG. 1, the movement amplitudes of the terminal end 122b of the first actuating arm 122 and the terminal end 123b of the second actuating arm 123 in the first direction are also increased significantly; since the terminal end 122b of the first actuating arm 122 and the terminal end 123b of the second actuating arm 123 conduct the movements to the diaphragm 130, the movement amplitude of the diaphragm 130 in the first direction is also increased significantly; therefore, a chip with a same dimension can set a larger volume of air in motion to create a higher sound pressure level.

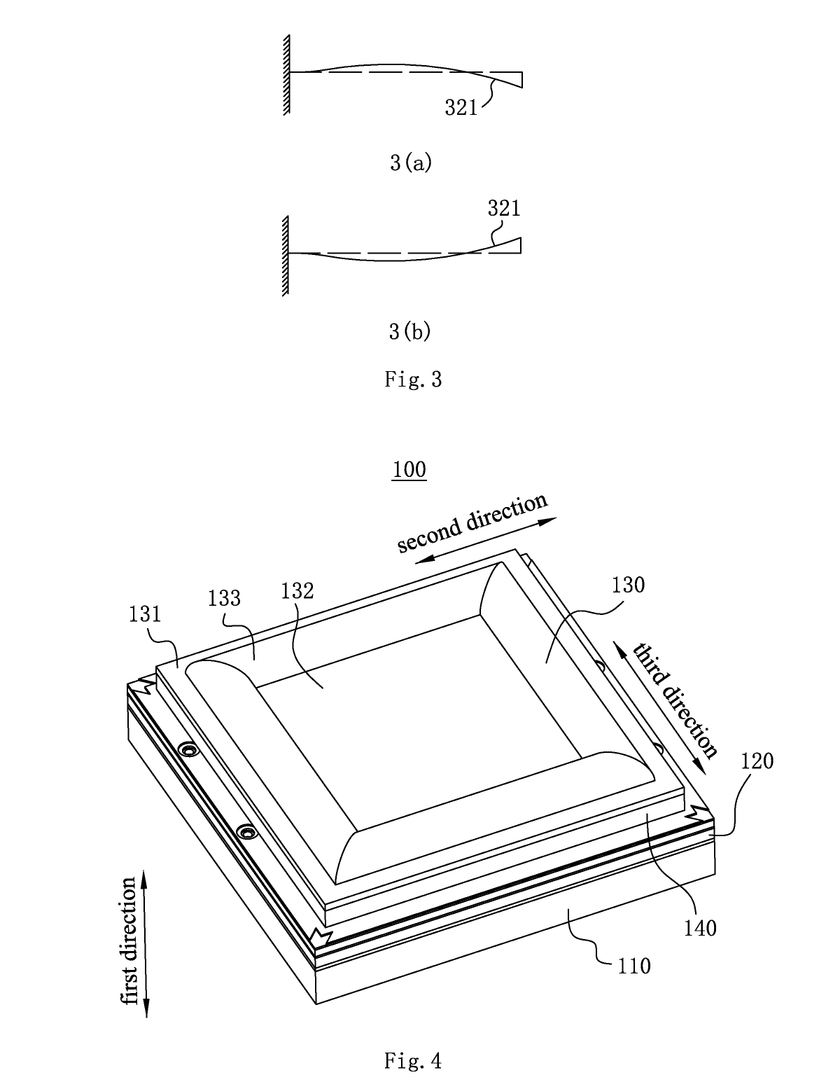

In another conventional technology as illustrated in FIG. 2, the electroacoustic transductor structure 300 comprises a base 310, an actuator 320, and a diaphragm 330. The base 310 has a cavity 311. The actuator 320 comprises two cantilevers 321 oppositely extended, one end of each of the cantilevers 321 being fixed to the base 310, another end thereof being free, and the diaphragm 330 is fixed to the fixed ends of the cantilevers 321 via a transmission part. Excited by an electrical signal, the free ends of the cantilevers 321 vibrate vertically to produce a sound pressure. However, in the secondary vibration mode, as illustrated in FIG. 3, irrespective of in a first vibrating state shown in FIG. 3(a) or a second vibrating state shown in FIG. 3(b), the cantilevers 321 partially move upward and partially move downward, the air volume pushed upward being partially cancelled by the air volume pushed downward, resulting in decrease of the total air volume set in motion by the diaphragm 330 and thusly a lower sound pressure level.

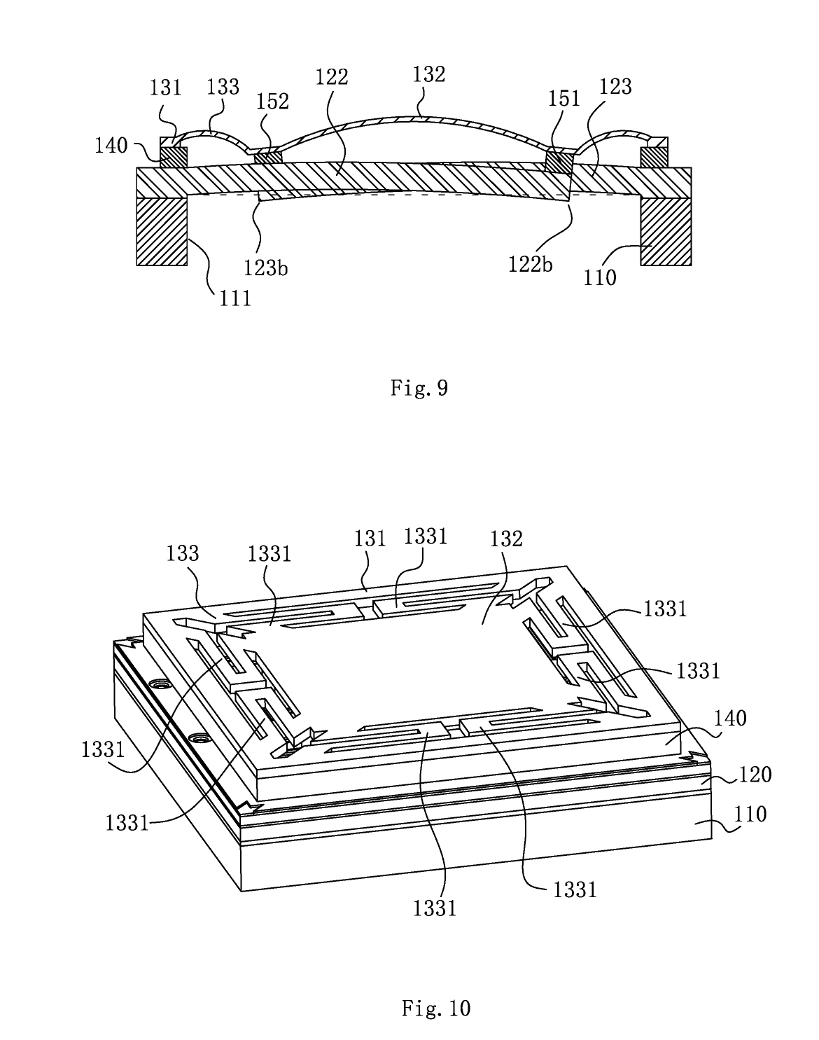

FIG. 9 illustrates a first vibrating state when this implementation is in the secondary vibration mode. Driven by an electrical signal, the terminal end 122b of the first actuating arm 122 and the terminal end 123b of the second actuating arm 123 are in a state of pointing downward. However, since the actuating mechanism 120 is covered by the diaphragm 130, when the edge of the body part 132 of the diaphragm 130 is driven by downward movements of the terminal 122b of the first actuating arm 122 and the terminal end 123b of the second actuating arm 123, the body part 132 either translates with the edge of the body part 132 or is bent by the body part 132 into an arched shape illustrated in FIG. 9, thereby preventing decrease of the total air volume set in motion by the diaphragm in the conventional technology illustrated in FIG. 2. It would be understood that, in this implementation, it depends on rigidity of the body part 132 whether the body part 132 translates with the edge of the body part 132 or is bent into an arched shaped.

In some implementations, as illustrated in FIGS. 4 -11 and 13-17, the electroacoustic transductor structure 100 further comprises a frame 140, a first transmission part 151, and a second transmission part 152. The frame 140 is set surrounding the first direction; in the first direction, the frame 140 is disposed between the edge part 131 and the fixed part 121, the edge part 131 being connected to the fixed part 121 via the frame 140. In the first direction, the first transmission part 151 is disposed between the terminal end 122b of the first actuating arm 122 and a third end 132a of the body part 132, the third end 132a of the body part 132 being connected to the terminal end 122b of the first actuating arm 122 via the first transmission part 151. In the first direction, the second transmission part 152 is disposed between the terminal end 123b of the second actuating arm 123 and a fourth end 132b of the body part 132, the fourth end 132b of the body part 132 being connected to the terminal end 123b of the second actuating arm 123.

In this implementation, in the first direction, the diaphragm 130 is connected to the actuating mechanism 130 via the frame 140, the first transmission part 151, and the second transmission part 152, which can increase a distance between the diaphragm 130 and the actuating mechanism 120 in the first direction, preventing the actuating mechanism 120 from interfering with the vibrating diaphragm 130.

In some implementations, the connecting part 133 is a flexible structure so that the body part 132 may vibrate with the first actuating arm 122 and the second actuating arm 123 relative to the edge part 131 in the first direction.

As an implementation, referring to the examples illustrated in FIGS. 4-9, 15, and 16, the connecting part 133 is formed of a surround structure. Exemplarily, the connecting part 133 may be of a surround structure with its central portion raised in the first direction away from the base 110.

As an implementation, referring to the examples illustrated in FIGS. 10-12, the connecting part 133 comprises a plurality of spring arms 1331 arranged at intervals surrounding the first direction. One end of each spring arm 1331 is connected to the edge part 131, and another end thereof is connected to the body part 132.

Exemplarily, as illustrated in FIGS. 10-12, the body part 132 and the edge part 131 have a square structure with their outer contours copied with each other. The body part 132 and the edge part 131 have their diagonals coincide; an edge portion of the body part 132 is connected to a corresponding edge portion of the edge part 131 via two spring arms 1331; moreover, the two spring arms 1331 on a same edge portion are symmetrically disposed. Each of the spring arms 1331 comprises a first connecting segment 1332, a second connecting segment 1333, a third connecting segment 1334, a fourth connecting segment 1335, and a fifth connecting segment 1335, which are sequentially connected into one piece. In each spring arm 1331, the first connecting segment 1332 and the fifth connecting segment 1336 are parallel to the diagonal of the diaphragm 130, the first connecting segment 1332 is connected to the body part 132 and disposed adjacent the diagonal, the fifth connecting segment 1336 is connected to the edge part 131 and disposed adjacent the diagonal, the second connecting segment 1333 and the fourth connecting segment 1335 are parallel to the edge portion where the spring arms 1331 are disposed, and the third connecting segment 1334 is perpendicular to the edge portion where the spring arms 1331 are disposed.

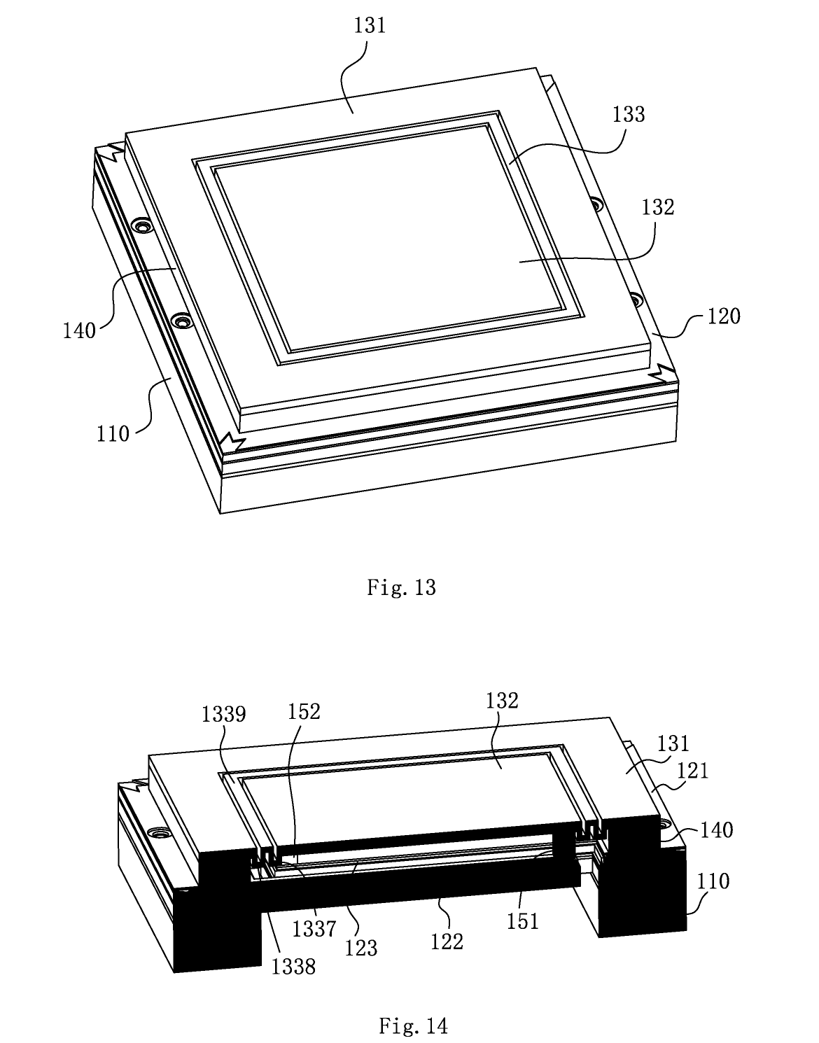

As an implementation, referring to the examples illustrated in FIGS. 13-14, the connecting part 133 comprises concaves and a convex 1339, in which at least two concaves are provided, each concave surrounding the first direction, all concaves being co-axially arranged; the convex 1339 is configured to connect adjacent two concaves into one piece; the concaves are recessed towards the base 110 relative to the body part 132.

As an example, referring to FIG. 14, the connecting part 133 may comprise a first concave 1337, a second concave 1338, and a convex 1339, among which the first concave 1337 is set surrounding an outer peripheral edge of the body part 132, the convex 1339 is set surrounding an outer peripheral edge of the first concave 1337, the second concave 1338 is set surrounding an outer peripheral edge of the convex 1339, and the edge part 131 is set surrounding an outer peripheral edge of the second concave 1338.

It is noted that, in an alternative implementation, the connecting part 133 may be formed of another structure, which may be set dependent on actual conditions and thusly will not be detailed here.

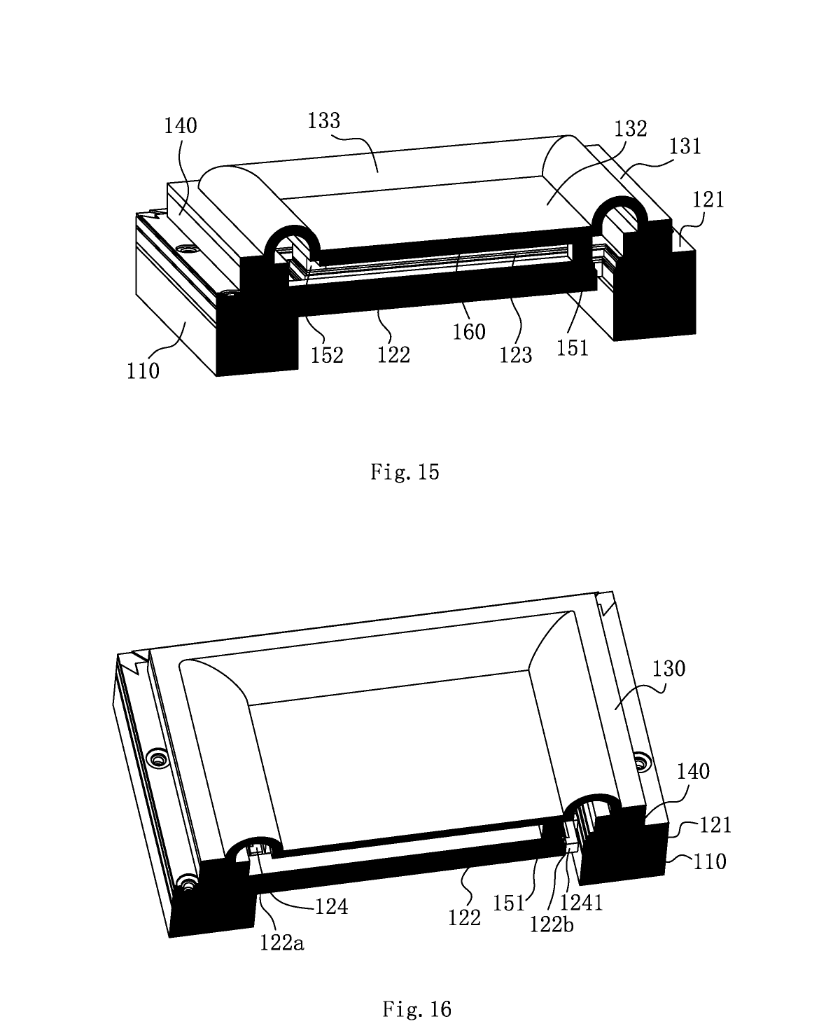

In some implementations, as illustrated in FIG. 15, the electroacoustic transductor structure 100 further comprises a rigidity adjustment plate 160. The rigidity adjustment plate 160 may cover one side of the body part 132 proximal to the base 110 in the first direction; a rigidity of the rigidity adjustment plate 160 is greater than a rigidity of the body part 132, which may effectively enhance the rigidity of the body part 132 so that the diaphragm 130 may vibrate in a preset vibrating manner. It would be understood that, a specific rigidity of the rigidity adjustment plate 160 may be set dependent on actual conditions, which is thusly not detailed here.

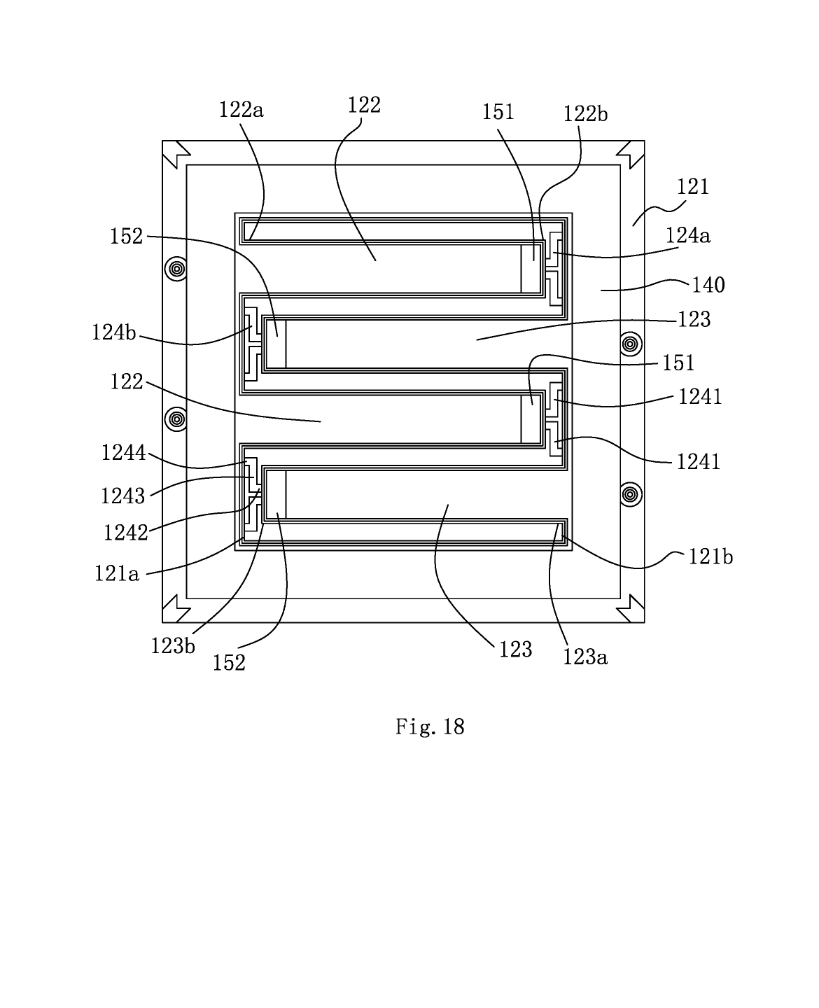

In some implementations, as illustrated in FIGS. 5 and 18, the actuating mechanism 120 comprises a plurality of first actuating arms 122 and a plurality of second actuating arms 123; moreover, a number of the first actuating arms 122 is identical to that of the second actuating arms 123; a length of each first actuating arm 122 in the second direction is identical to that of each second actuating arm 123 in the second direction; the first actuating arms 122 and the second actuating arms 123 are alternately arranged in a third direction at intervals, the third direction being perpendicular to the first direction and the second direction. The terminal end 122b of each first actuating arm 122 is connected to the third end 132a of the body part 132, respectively, and the terminal end 123b of each second driving portion 123 is connected to the fourth end 132b of the body part 132, respectively.

Exemplarily, referring to FIG. 5 and FIG. 18, the actuating mechanism 120 may comprise two first actuating arms 122 and two second actuating arms 123. It is noted that, in an alternative implementation, the actuating mechanism 120 may further comprise another number of first actuating arms 122 and another number of the second actuating arms 123, which may be set dependent on actual conditions and is thusly not detailed here.

In some implementations, referring to FIGS. 16-18, the actuating mechanism 120 further comprises a spring part 124, the spring part 124 being partitioned into a first spring part 124a and a second spring part 124b, the terminal end 122b of the first actuating arm 122 being connected to the second end 121b of the fixed part 121 via the first spring part 124a, the terminal end 123b of the second actuating arm 123 being connected to the first end 121a of the fixed part 121 via the second spring part 124b.

In this implementation, the first spring part 124a and the second spring part 124b as provided may prevent the terminal end 122b of the first actuating arm 122 and the terminal end 123b of the second actuating arm 123 from moving with an excessive amplitude causing an excessive harmonic distortion of sound, which can also effectively prevent the first actuating arm 122 and the second actuating arm 123 from being excessively deformed causing fracture of the first actuating arm 122 and the second actuating arm 123.

Exemplarily, referring to FIG. 18, the spring part 124 may comprise two spring structures 1241 arranged symmetrically about the central axis of the corresponding actuating arm. Each of the spring structure 1241 comprises a first elastic segment 1242, a second elastic segment 1243, and a third elastic segment 1244 that are sequentially connected, the first elastic segment 1242 and the third elastic segment 1244 being parallel to the second direction, the second elastic segment 1243 being parallel to the third direction, the first elastic segment 1242 being connected to the terminal end of the corresponding actuating arm, and the third elastic segment 1244 being connected to the fixed part 121.

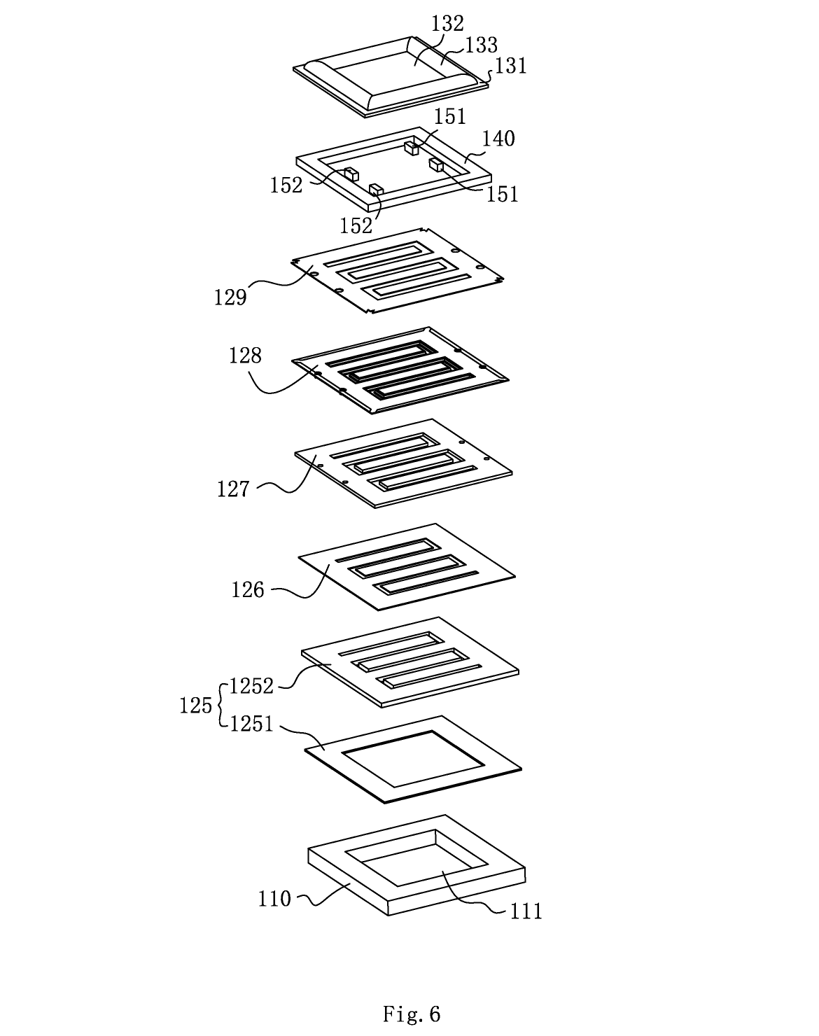

In some implementations, referring to FIG. 6, the actuating mechanism 120 comprises a support layer 125, a first electrode layer 126, a piezoelectric layer 127, and a second electrode layer 128 which are sequentially arranged in the direction away from the base 110, the support layer 125 being connected to the base 110.

As one implementation, referring to FIG. 6, the actuating mechanism 120 further comprises a passivation layer 129, the passivation layer 129 being disposed at one side of the second electrode layer 128 distant from the piezoelectric layer 127.

Exemplarily, referring to FIG. 6, the support layer 125 may comprise a first support layer 1251 and a second support layer 1252 which are sequentially arranged in the first direction away from the base 110. The first support layer 1251 is of a frame structure and connected to the base 110. The first support layer 1251, the second support layer 1252, the first electrode layer 126, the piezoelectric layer 127, and the second electrode layer 128 jointly constitute the fixed part 121. The second support layer 1252, the first electrode layer 126, the piezoelectric layer 127, and the second electrode layer 128 jointly constitute the first actuating arm 122 and the second actuating arm 123.

What have been described are only example implementations of the present disclosure. It should be noted here that, a person of normal skill may modify the example implementations without departing from the invention idea of the present disclosure, and all such modifications fall within the scope of protection of the present disclosure.

We claim:

1. An electroacoustic transductor structure, comprising:
a base having a cavity, the cavity having two openings oppositely arranged in a first direction;
an actuating mechanism comprising an annular fixed part that surrounds the first direction and is fixed to the base, a first actuating arm, and a second actuating arm, the first actuating arm and the second actuating arm being formed in the fixed part, respectively, the fixed part having a first end and a second end that are oppositely oriented in a second direction perpendicular to the first direction, the first actuating arm extending from the first end of the fixed part till adjacent the second end of the fixed part, the second actuating arm extending from the second end of the fixed part till adjacent the first end of the fixed part;
and a diaphragm which covers one of the openings, the diaphragm comprising an annular edge part which surrounds the first direction and is fixed to the fixed part, a body part located in a central area of the edge part and a connecting part elastically connecting the edge part and the body part, two ends of the body part in the second direction being fixed to a terminal end of the first actuating arm and a terminal end of the second actuating arm, respectively.

2. The electroacoustic transductor structure according to claim 1, wherein the connecting part has a surround structure a central portion of which is raised in a direction distant from the base.

3. The electroacoustic transductor structure according to claim 1, wherein the connecting part comprises a plurality of spring arms arranged at intervals surrounding the first direction, one end of each of the spring arms being connected to the edge part, another end of the each of the spring arms being connected to the body part.

4. The electroacoustic transductor structure according to claim 1, wherein the connecting part comprises at least two concaves arranged coaxially surrounding the first direction and a convex joining adjacent two concaves into one piece, the concaves being recessed towards the base relative to the body part.

5. The electroacoustic transductor structure according to claim 1, further comprising a rigidity regulating plate, the rigidity regulating plate covering one side of the body part proximal to the opening and being configurable to enhance rigidity of the body part.

6. The electroacoustic transductor structure according to claim 1, wherein the actuating mechanism comprises a plurality of the first actuating arms and a plurality of the second actuating arms, a number of the first actuating arms being identical to that of the second actuating arms, the first actuating arms and the second actuating arms being alternately arranged at intervals in a third direction, the third direction being perpendicular to the first direction and the second direction.

7. The electroacoustic transductor structure according to claim 1, wherein the actuating mechanism further comprises a first spring part and a second spring part;
the terminal end of the first actuating arm is connected to the second end of the fixed part via the first spring part;
and the terminal end of the second actuating arm is connected to the first end of the fixed part.

8. The electroacoustic transductor structure according to claim 1, wherein the actuating mechanism comprises a support layer, a first electrode layer, a piezoelectric layer, and a second electrode layer which are sequentially arranged in the first direction away from the base, the support layer being connected to the base.

9. The electroacoustic transductor structure according to claim 8, wherein the actuating mechanism further comprises a passivation layer, the passivation layer being disposed at one side of the second electrode layer distant from the piezoelectric layer.

10. The electroacoustic transductor structure according to claim 1, further comprising a frame surrounding the first direction, a first transmission part, and a second transmission part, the frame connecting the edge part and the fixed part, the first transmission part connecting the terminal end of the first actuating arm and the body part, the second transmission part connecting the terminal end of the second actuating arm and the body part.
